(19) United States
(12) Patent Application Publication
(10) Pub. No.: US 2018/0257078 A1
(43) Pub. Date: Sep. 13, 2018

(54) TEMPERATURE PROCESSING DEVICE, NUCLEIC ACID AMPLIFICATION REACTION DEVICE, AND TEMPERATURE PROCESSING METHOD

(71) Applicant: SONY CORPORATION, TOKYO (JP)

(72) Inventors: TATSUO MAEDA, KANAGAWA (JP); MASAMI OKITA, TOKYO (JP)

(21) Appl. No.: 15/759,732

(22) PCT Filed: Jul. 14, 2016
(86) PCT No.: PCT/JP2016/070812

§ 371 Date: Mar. 13, 2018

(30) Foreign Application Priority Data
Sep. 28, 2015 (JP) 2015-190351

(51) Int. Cl. B01L 7/00; G05B 11/32; G05D 23/19

(52) U.S. Cl. CPC B01L 7/52; G05D 23/1919; G05B 11/32

(57) ABSTRACT

Provided is a temperature control technique capable of avoiding occurrence of overshoot and/or undershoot. A temperature processing device includes: a PID control unit; an addition unit for adding a fixed value set between an output value corresponding to a change starting temperature and an output value corresponding to a target temperature to an output value output from the PID control unit; and a temperature control unit for controlling a temperature change from the change starting temperature to the target temperature using the result of adding the output value and the fixed value.

### TECHNICAL FIELD

The present technology relates to a temperature processing device, a nucleic acid amplification reaction device, and a temperature processing method. More specifically, for example, the present technology relates to a temperature processing device applied to a nucleic acid amplification device for amplifying and detecting a target nucleic acid, and the like.

### BACKGROUND ART

As disclosed in Patent Document 1, temperature control by PID control is applied to control of the opening degree of a supply valve of cooling water for cooling an engine, and control of temperature rise and temperature drop in a polymerase chain reaction (PCR) method applied to a nucleic acid amplification reaction device.

The PID control is a method for outputting the sum of a proportional controller for outputting an output proportional to a difference between a change starting temperature and a target temperature (hereinafter, also referred to as “deviation”), an integral controller for outputting an output proportional to an integral of the deviation, and a derivative controller for outputting an output proportional to a differentiation of the deviation, and feeding back this output (hereinafter, also referred to as “PID output”) to eliminate the deviation.

### CITATION LIST

### Patent Document

Patent Document 1: Japanese Patent Application Laid-Open No. 2008-180519

### SUMMARY OF THE INVENTION

### Problems to be Solved by the Invention

In an environment essentially requiring an operation of repeating a temperature change of a temperature rise operation or a temperature drop operation (hereinafter, also referred to as a “temperature cycle”), in a case where a temperature in the temperature cycle is controlled by PID control, an integral value needs to be erased when a target value is changed. As a result, a behavior of a transient response is restricted.

For example, in a case where PID control is applied to a case of lowering a temperature from a change starting temperature to a target temperature in a temperature cycle, a positive integral value required for maintaining the change starting temperature is erased at the time of setting the target temperature.

Then, a difference indicating a negative is fed back. As a result, cooling starts and the temperature is lowered. Until the temperature reaches the target temperature, the sign of the difference does not change and cooling continues. Therefore, when the target temperature is reached, the integral value takes a negative value.

Meanwhile, in order to maintain this target temperature after the target temperature is reached, heating is necessary, and the integral value needs to take a positive value. Therefore, in order to reach convergence, it is necessary to maintain a state below the target temperature and to make the integral value of the difference positive.

That is, in a case where temperature control by PID control is performed in a temperature drop operation, occurrence of undershoot cannot be avoided.

This phenomenon also occurs in a case where a temperature is raised from a lower temperature to a temperature not reaching 0° C. in an environment of, for example, 0° C. or less, and in such a case, occurrence of overshoot cannot be avoided.

Particularly, in a gene amplification reaction method for repeating a temperature cycle in a short time, requiring rapidly reaching a target temperature and stabilizing a temperature at the target temperature after the target temperature is reached, such as a PCR method, it is necessary to maintain a temperature optimum for enzyme activity for a constant time. Therefore, it is required to avoid occurrence of overshoot and/or undershoot.

Therefore, a main object of the present technology is to provide a temperature control technique capable of avoiding occurrence of overshoot and/or undershoot.

### Solutions to Problems

That is, the present technology provides a temperature processing device including: a PID control unit; an addition unit for adding a fixed value set between an output value corresponding to a change starting temperature and an output value corresponding to a target temperature to an output value output from the PID control unit; and a temperature control unit for controlling a temperature change from the change starting temperature to the target temperature using the result of adding the output value and the fixed value.

This temperature processing device may further include a fixed value setting unit for calculating the fixed value on the basis of a difference between the output value and an output value corresponding to a target temperature.

In addition, in this temperature processing device, the fixed value may be an intermediate value between an output value corresponding to the change starting temperature and an output value corresponding to a target temperature.

Furthermore, in this temperature processing device, the fixed value setting unit may calculate the fixed value on the basis of a predetermined first control value and a second control value determined on the basis of an output value corresponding to a subsequent target temperature.

In addition, in this temperature processing device, by updating the second control value using the first control value and a third control value calculated on the basis of an output value corresponding to a current target temperature, the fixed value setting unit may calculate a fourth control value, and may calculate the fixed value on the basis of the first control value and the fourth control value.

This temperature processing device may further include a PID coefficient determination unit for determining a PID coefficient on the basis of an input value input to the PID control unit, and the fixed value setting unit may calculate the fixed value using the PID coefficient.

In addition, this temperature processing device may further include an erasure processing unit for deleting an integral value output from the PID control unit.

In addition, the present technology also provides a nucleic acid amplification reaction device including a temperature processing device including: a PID control unit; an addition unit for adding a fixed value set between an output value corresponding to a change starting temperature and an output value corresponding to a target temperature to an output value output from the PID control unit; and a temperature control unit for controlling a temperature change from the change starting temperature to the target temperature using the result of adding the output value and the fixed value.

Furthermore, the present technology provides a temperature processing method including: a PID control step of subjecting an input value to PID control; an addition step of adding a fixed value set between an output value corresponding to a change starting temperature and an output value corresponding to a target temperature to an output value output in the PID control step; and a temperature control step of controlling a temperature change from the change starting temperature to the target temperature using the result of adding the output value and the fixed value.

In addition, this temperature processing method may further include a fixed value calculation step of calculating the fixed value on the basis of a difference between the output value and an output value corresponding to a target temperature.

Furthermore, in this temperature processing method, in the fixed value calculation step, the fixed value may be calculated as an intermediate value between an output value corresponding to the change starting temperature and an output value corresponding to a target temperature.

In addition, in this temperature processing method, in the fixed value calculation step, the fixed value may be calculated on the basis of a predetermined first control value and a second control value predetermined on the basis of an output value corresponding to a subsequent target temperature.

In this temperature processing method, the fixed value calculation step may further include an updating step of calculating an updated second control value by updating the second control value using the first control value and a third control value calculated on the basis of an output value corresponding to a current target temperature, and the fixed value may be calculated on the basis of the first control value and the updated second control value.

In addition, this temperature processing method may further include a PID coefficient determination step of determining a PID coefficient in the PID control unit on the basis of an input value input to the PID control unit. In the fixed value calculation step, the fixed value may be calculated using the PID coefficient.

Furthermore, this temperature processing method may further include an erasure processing step of deleting an integral value output from the PID control unit.

### Effects of the Invention

The present technology can avoid occurrence of overshoot and/or undershoot.

Note that effects described herein are not necessarily limited, and may be any of effects described in the present technology.

### BRIEF DESCRIPTION OF DRAWINGS

FIG. 1 is a schematic conceptual diagram schematically exemplifying a temperature processing device according to the present technology.

FIG. 2 is a conceptual diagram illustrating a configuration of a temperature processing unit illustrated in FIG. 1.

FIG. 3 is a flowchart illustrating an operation of the temperature processing device illustrated in FIG. 1.

FIG. 4 is a flowchart exemplifying a parameter setting step illustrated in FIG. 3.

FIG. 5 is a flowchart illustrating a first modified example of the parameter setting step illustrated in FIG. 4.

FIG. 6 is a flowchart illustrating a second modified example of the parameter setting step illustrated in FIG. 4.

FIG. 7 is a flowchart illustrating a third modified example of the parameter setting step illustrated in FIG. 4.

FIG. 8 is a flowchart illustrating a calculation step in a fixed value setting unit illustrated in FIG. 1.

FIG. 9 is a diagram exemplifying a table used for determining a fixed value.

FIG. 10 is a flowchart illustrating a first modified example of the calculation step illustrated in FIG. 8.

FIG. 11 is a flowchart illustrating a second modified example of the calculation step illustrated in FIG. 8.

FIG. 12 is a schematic conceptual diagram schematically illustrating a nucleic acid amplification reaction device according to the present technology.

FIG. 13 is a graph substitute diagram illustrating a temperature control result in the nucleic acid amplification reaction device according to the present technology.

### MODE FOR CARRYING OUT THE INVENTION

Hereinafter, preferred embodiments for performing the present technology will be described with reference to the drawings. Note that the embodiments described below exemplify representative embodiments of the present technology, and the scope of the present technology is not narrowly interpreted by the embodiments. Note that the description will be made in the following order.

1. Temperature processing device

(1) Processing unit

(2) Storage unit

(3) Temperature processing unit

(4) PID control unit

(5) Addition unit

(6) Temperature control unit

(7) Fixed value setting unit

(8) PID coefficient determination unit

(9) Erasure processing unit

(10) Target temperature setting unit

(11) Heating/cooling unit

2. Nucleic acid amplification reaction device

(1) Temperature processing unit

(2) Reaction unit

(3) Heating/cooling unit

(4) Light source

(5) Light guide plate

(6) Fluorescence detection unit

(7) Filter film

3. Temperature processing method

(1) Target temperature setting step

(2) Erasure processing step

(3) PID coefficient determination step

(4) Fixed value calculation step

(5) PID control step

(6) Addition step

(7) Temperature control step

(8) Heating/cooling step

1. Temperature Processing Device

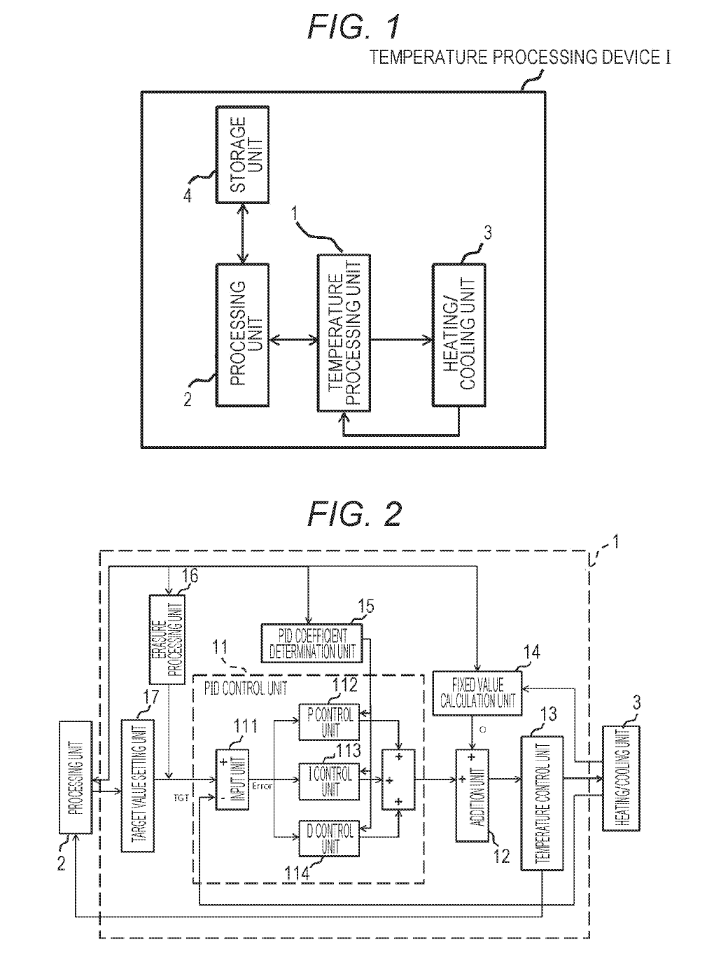

FIG. 1 is a schematic conceptual diagram exemplifying a temperature processing device according to the present technology. An application example illustrated in FIG. 1 is a temperature processing device I for performing a temperature change from a change starting temperature TMP to a target temperature TGT. The temperature processing device I includes a heating/cooling unit 3 for performing temperature adjustment of a temperature control target, a temperature processing unit 1 for controlling a temperature adjustment operation of the heating/cooling unit 3, a processing unit 2 for setting a target temperature TGT for the temperature processing unit 1, and a storage unit 4 storing information regarding a change of a set temperature with time or the like.

Note that the processing unit 2, the heating/cooling unit 3, and the storage unit 4 are not essential in the temperature processing device I. Hereinafter, the temperature processing unit 1, the processing unit 2, the heating/cooling unit 3, and the storage unit 4 will be described.

(1) Processing Unit

The processing unit 2 controls processing of each unit constituting the temperature processing device I according to an instruction stored in the storage unit 4. Here, the processing unit 2 receives information regarding a change of a set temperature with time (hereinafter, also referred to as “time sequence”) stored in the storage unit 4, and sets a target temperature TGT according to the time sequence. Then, the processing unit 2 outputs the set target temperature TGT to the temperature processing unit 1. The processing unit 2 can adopt a known configuration as long as being able to set a target temperature TGT. In addition, a method for setting the target temperature TGT in the processing unit 2 is not particularly limited, and a known method can be adopted.

(2) Storage Unit

The storage unit 4 stores information regarding a change of a set temperature with time in a case where a temperature is changed from a change starting temperature TMP to a target temperature TGT. In addition, the storage unit 4 sends the target temperature TGT to the processing unit 2 at a specified time, for example, at the time when a temperature drop operation is changed to a temperature rise operation. Such a storage unit 4 can use a known configuration as long as being able to store information, such as a central processing unit (CPU), a read only memory (ROM), or a random access memory (RAM). The storage unit 4 is not essential in the temperature processing device I according to the present technology. For example, the storage unit 4 can be connected to an external storage device such that the external storage device stores information regarding a change of a set temperature with time.

(3) Temperature Processing Unit

Next, the temperature processing unit 1 which is a characteristic configuration of the present technology will be described with reference to FIG. 2. The temperature processing unit 1 according to the present technology performs temperature control in a case where a change starting temperature TMP is changed to a target temperature TGT, and includes at least a PID control unit 11, an addition unit 12, and a temperature control unit 13. The temperature processing unit 1 according to the present technology may include a fixed value setting unit 14, a PID coefficient determination unit 15, an erasure processing unit 16, and a target value setting unit 17 as necessary. Each unit will be described below.

(4) PID Control Unit

The temperature processing unit 1 according to the present technology includes the PID control unit 11 for performing PID control on an output value corresponding to a target temperature TGT output from the target value setting unit 17 described later. The PID control unit 11 includes an input unit 111 to which a target temperature TGT is input, a P control unit 112 for performing a proportional operation to output an output proportional to a difference value (error) output from the input unit 111, an I control unit 113 for performing an integral operation to output an output proportional to integration of the difference value, and a D control unit 114 for performing a differential operation to output an output proportional to differentiation of the difference value.

The configuration of the input unit 111 is not particularly limited, and a known configuration can be adopted. In addition, in a case where there is a difference between an output value corresponding to an input target temperature TGT and an output value corresponding to a target temperature TGT actually required, the input unit 111 outputs the difference value (error) to the P control unit 112, the I control unit 113, and the D control unit 114.

Furthermore, the input unit 111 also adopts a configuration in which a control value output from the temperature control unit 13 to the heating/cooling unit 3 is fed back, and feedback control is performed. Note that the “output value corresponding to a target temperature TGT” is a value constantly output in order to maintain a state of a target temperature TGT.

Furthermore, the PID control unit 11 adds an output value of the P control unit 112, an output value of the I control unit 113, and an output value of the D control unit 114 together, and outputs the added output value (hereinafter, also referred to as a “PID output value”) to the addition unit 12. Note that the PID output value may be fed back to the processing unit 2 in the present technology. Each of the configurations of the P control unit 112, the I control unit 113, and the D control unit 114 is not particularly limited, and can adopt a known configuration as long as being able to perform usual PID control.

(5) Addition Unit

The temperature processing unit 1 according to the present technology includes the addition unit 12 for adding a fixed value O to a PID output value output from the PID control unit 11.

The addition unit 12 performs calculation processing for adding the fixed value O to the PID output value. This calculation method is not particularly limited, and a known method can be adopted.

In addition, in a case where the addition unit 12 judges that there is a deviation between the PID output value and an output value corresponding to a target temperature TGT, the addition unit 12 instructs the fixed value setting unit 14 to calculate a fixed value O. A method for judging the deviation in the addition unit 12 is not particularly limited, and a known method can be adopted.

In addition, an addition result calculated by the addition unit 12 is output to the temperature control unit 13. Here, in a case where a difference between the PID output value output from the PID control unit 11 and the output value corresponding to a target temperature TGT is 0, the addition unit 12 does not have to add the fixed value O.

(6) Temperature Control Unit

The temperature processing unit 1 according to the present technology includes the temperature control unit 13. To the temperature control unit 13, an addition result output from the addition unit 12 is input. The temperature control unit 13 calculates a control value for controlling a temperature change from a change starting temperature TMP to a target temperature TGT according to the addition result. This control value is output to the heating/cooling unit 3.

Meanwhile, in a case where there is a difference between the addition result input to the temperature control unit 13 and the output value corresponding to a target temperature TGT, the control value output from the temperature control unit 13 is fed back to the processing unit 2, and is subjected to PID control by the PID control unit 11 again. This feedback operation is repeated until the difference between the control value and the output value corresponding to the target temperature TGT becomes zero.

Meanwhile, in a case where the difference between the addition result output from the addition unit 12 and the output value corresponding to the target temperature TGT is 0, the temperature control unit 13 does not perform calculation processing, and the addition result output from the addition unit 12 is output to the heating/cooling unit 3.

(7) Fixed Value Setting Unit

In the temperature processing unit 1 according to the present technology, by adding a fixed value O to the PID output value, when the temperature of a temperature control target reaches a target temperature TGT, the sign of an integral value can be inverted.

Therefore, the temperature processing unit 1 according to the present technology preferably includes the fixed value setting unit 14 for determining the fixed value O as necessary.

A method for calculating the fixed value O in the fixed value setting unit 14 is not particularly limited, and various methods can be adopted appropriately. Examples thereof include a method for receiving a target temperature TGT from the processing unit 2 and calculating a fixed value O on the basis of the target temperature TGT, a method for calculating a fixed value O on the basis of a difference between a PID output value and an output value corresponding to a target temperature TGT and the like. An example of a method for calculating a fixed value O in the fixed value setting unit 14 will be described later.

Then, the fixed value O calculated by the fixed value setting unit 14 is output to the addition unit 12. In addition, in the temperature processing unit 1 according to the present technology, the fixed value O calculated by the fixed value setting unit 14 may be fed back to the processing unit 2. Furthermore, the fixed value O fed back to the processing unit 2 may be stored in the storage unit 4.

(8) PID Coefficient Determination Unit

In a case where PID control is performed in the PID control unit 11, if a proportional band, integration time, and differentiation time are not appropriate, the control becomes unstable, and occurrence of hunting may be induced after temperature control.

Therefore, the temperature processing unit 1 according to the present technology preferably includes the PID coefficient determination unit 15 for determining a coefficient KP of a proportional element, a coefficient KI of an integral element, and a coefficient KD of a differential element in the PID control unit 11.

Similarly to the fixed value setting unit 14, the PID coefficient determination unit 15 receives a target temperature TGT from the processing unit 2 and determines a PID coefficient on the basis of the target temperature TGT.

Then, the PID coefficient determined by the PID coefficient determination unit 15 is output to the P control unit 112, the I control unit 113, and the D control unit 114 included in the PID control unit 11.

The configuration of the PID coefficient determination unit 15 is not particularly limited, and can adopt a known configuration applied for determining a PID coefficient.

Note that a PID coefficient determined by the PID coefficient determination unit 15 may be fed back to the processing unit 2, and that the PID coefficient fed back to the processing unit 2 may be stored in the storage unit 4.

(9) Erasure Processing Unit

Usually, in a case where the temperature of a temperature control target is changed from a change starting temperature TMP to a target temperature TGT, an effect of suppressing a change of an integral value is obstructive. Therefore, when the temperature is changed to the target temperature TGT, the integral value is erased.

Therefore, at the time when a temperature change from the change starting temperature TMP to the target temperature TGT is requested, the temperature processing unit 1 according to the present technology needs to erase an integral value which has been necessary for maintaining the change starting temperature TMP.

Therefore, the temperature processing unit 1 according to the present technology preferably includes the erasure processing unit 16 for erasing the integral value. At the time when the request for changing the temperature to the target temperature TGT is made, the erasure processing unit 16 receives an instruction from the processing unit 2 and erases the integral value. The configuration of the erasure processing unit 16 is not particularly limited, and can adopt a known configuration as long as being able to erase the integral value.

(10) Target Value Setting Unit

The temperature processing unit 1 according to the present technology may include the target value setting unit 17 for setting the target temperature TGT. The target value setting unit 17 outputs an output value corresponding to the target temperature TGT to the input unit 111 included in the PID control unit 11. The configuration of the target value setting unit 17 is not particularly limited, and may adopt a known configuration as long as being able to input and output the target temperature TGT.

(11) Heating/Cooling Unit

A control value output from the temperature processing unit 1 configured as described above is input to the heating/cooling unit 3. The heating/cooling unit 3 includes a heating portion contributing to a temperature rise operation and a cooling portion contributing to a temperature drop operation. In a case where a target temperature TGT is set to a value higher than a change starting temperature TMP, the heating portion operates according to a control value output from the temperature processing unit 1 to raise the temperature of a temperature control target. Meanwhile, in a case where a target temperature TGT is set to a value lower than a change starting temperature TMP, the cooling portion operates according to a control value output from the temperature processing unit 1 to lower the temperature of a temperature control target.

The configuration of such a heating/cooling unit 3 is not particularly limited, and can use a known member such as a Peltier element, for example.

The heating/cooling unit 3 may feed back the actual temperature of a temperature control target to be subjected to temperature adjustment to the input unit 111 of the temperature processing unit 1.

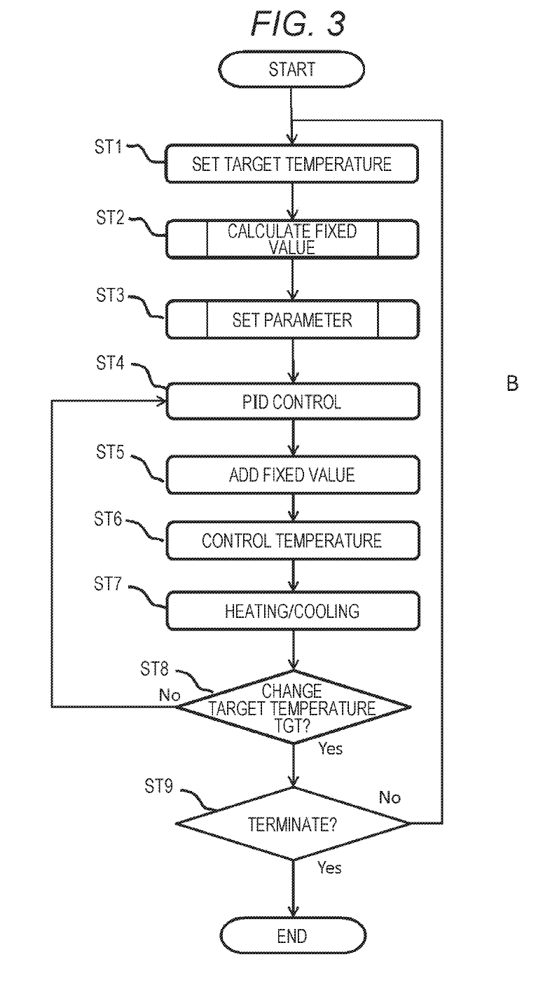

Hereinafter, a series of operations of the temperature processing device I including the above units will be described with reference to FIG. 3.

In the temperature processing device I, first, in a case where the temperature is changed from a change starting temperature TMP to a target temperature TGT, information regarding a change of a set temperature with time is sent to the processing unit 2 from the storage unit 4, and the processing unit 2 sets the target temperature TGT (ST1).

Thereafter, the fixed value O is calculated (ST2) as necessary. Furthermore, parameter setting such as a PID coefficient used for PID control performed by the PID control unit 11 or erasure of an integral value is performed (ST3). The step of calculating a fixed value O and the parameter setting step will be described in detail later.

After each parameter is set, the temperature processing device I according to the present technology performs PID control on an output value output from the target value setting unit 17 to the PID control unit 11 (ST4).

Furthermore, in order to avoid occurrence of undershoot or overshoot during temperature control, the addition unit 12 adds a predetermined fixed value O to a PID output value output from the PID control 11 (ST5).

Thereafter, the addition result obtained by adding the fixed value O to the PID output value is output to the temperature control unit 13. Furthermore, the temperature control unit 13 calculates a control value for controlling a temperature change from a change starting temperature TMP to a target temperature TGT. Then, the control value calculated by the temperature control unit 13 is output to the heating/cooling unit 3 (ST6).

Furthermore, in the temperature processing device I according to the present technology, the heating/cooling unit 3 operates on the basis of a control value output from the temperature control unit 13, and heats or cools a temperature control target (ST7).

Thereafter, the processing unit 2 judges whether the target temperature TGT is changed (ST8). Then, in a case where it is necessary to change the target temperature TGT (YES in ST8), the processing unit 2 judges whether a control operation is terminated (ST9). Then, it is judged that the control is not terminated (NO in ST9), the storage unit 4 sends information regarding a change of a set temperature with time to the processing unit 2 again, and a target temperature TGT is set. Meanwhile, in a case where it is judged that the control is terminated (YES in ST9), the control operation is terminated.

In addition, in the temperature processing device I according to the present technology, in a case where there is a difference between a temperature output from the heating/cooling unit 3 and a target temperature TGT, the heating/cooling unit 3 does not heat or cool a temperature control target, and the temperature control target is subjected to PID control again. Thereafter, operations such as addition of a fixed value and calculation of a control value are repeated again (NO in ST8).

Furthermore, the temperature processing device I according to the present technology also embodies a temperature cycle in which temperature rise and temperature drop are repeated like “thermal denaturation→annealing (primer hybridization)→extension reaction” in the PCR method. Therefore, in a case where the temperature processing device I performs a temperature cycle, after heating or cooling in the heating/cooling unit 3 is performed, the processing unit 2 judges whether the target temperature TGT is changed (ST8). Then, in a case where the target temperature TGT is changed, for example, in a case where a temperature rise operation is changed to a temperature drop operation (YES in ST8), the processing unit 2 does not judge that the control operation is terminated (NO in ST9), the storage unit 4 sends information regarding a change of a set temperature with time to the processing unit 2, and the processing of ST1 to ST7 is repeated. This repeating operation is performed for each temperature change in the temperature cycle.

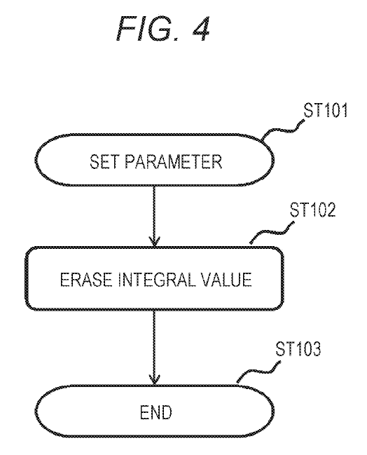

Next, an example of a parameter setting method illustrated in FIG. 3 will be described in detail with reference to FIGS. 4 to 7. In the following description, temperature control during temperature drop in a case where a change starting temperature TMP is 100° C. and a target temperature TGT is 60° C. will be described, but this is merely an example. The present technology can be applied not only to temperature control during temperature drop but also to temperature control during temperature rise.

In the present technology, as illustrated in FIG. 4, first, the processing unit 2 sets a target temperature TGT, and then the processing unit 2 gives an instruction on start of parameter setting (ST101).

Then, as described above, in a case where the temperature is raised or lowered from a change starting temperature TMP to the target temperature TGT, an integral value in temperature control takes a positive or negative value. Therefore, at the time when the target temperature TGT is reached, undershoot or overshoot may occur.

Therefore, in the temperature processing device I according to the present technology, when parameter setting is started, the erasure processing unit 16 operates and erases an integral value which has been necessary for maintaining the change starting temperature TMP (ST102).

In this way, parameter setting is terminated (ST103). As illustrated in FIG. 3, control by the PID control unit 11, the addition unit 12, and the temperature control unit 13 is started with respect to the newly set target temperature TGT.

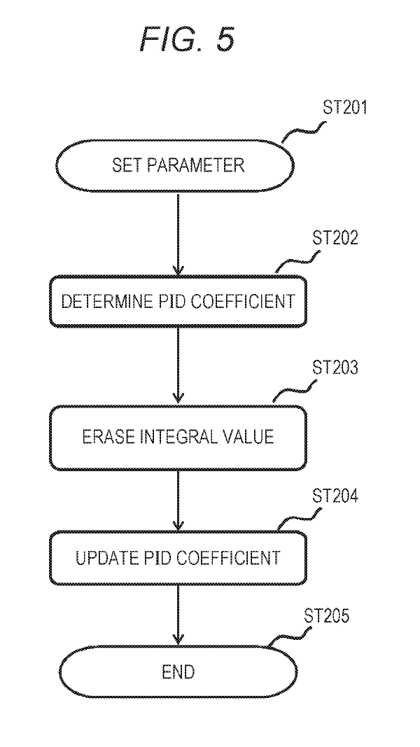

FIG. 5 is a flow illustrating a modified example of the parameter setting method. In the method illustrated in FIG. 5, first, the processing unit 2 sets a target temperature TGT, and then the processing unit 2 gives an instruction on start of parameter setting (ST201).

Thereafter, in a case where it is necessary to prevent occurrence of hunting after temperature control, the processing unit 2 gives an instruction to the PID coefficient determination unit 15, and a PID coefficient corresponding to the target temperature TGT is determined (ST202). Note that a method for determining the PID coefficient corresponding to the target temperature TGT is not particularly limited, and the PID coefficient may be calculated from a table prepared in advance, for example.

Furthermore, similarly to the method illustrated in FIG. 4, the erasure processing unit 16 erases a positive integral value which has been necessary for maintaining a change starting temperature TMP (100° C.) (ST203).

Furthermore, the PID coefficient determination unit 15 updates a PID coefficient from an existing PID coefficient to a newly determined PID coefficient as a result of new determination of the PID coefficient (ST204).

Then, parameter setting is terminated (ST205). Control by the PID control unit 11 based on the newly determined PID coefficient and control by the addition unit 12 and the temperature control unit 13 are started with respect to a newly set target temperature TGT (see ST4 and subsequent steps in FIG. 3).

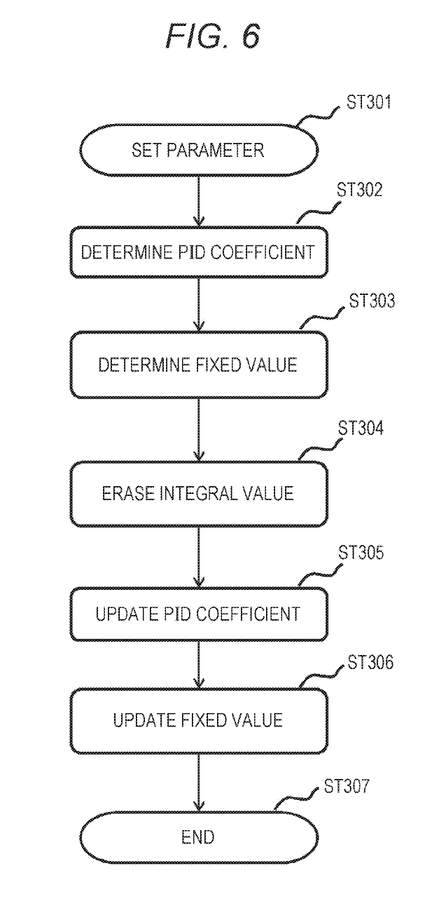

Furthermore, the temperature processing device I according to the present technology can adopt a parameter setting method illustrated in FIG. 6.

That is, first, the processing unit 2 sets a target temperature TGT, and then the processing unit 2 gives an instruction on start of parameter setting (ST301). Subsequently, the processing unit 2 gives an instruction to the PID coefficient determination unit 15, and a PID coefficient corresponding to a target temperature TGT is determined (ST302).

Thereafter, the determined PID coefficient is output to the P control unit 112, the I control unit 113, and the D control unit 114, and a PID output value based on the determined PID coefficient is output from the PID control unit 11 to the addition unit 12.

Then, in a case where there is a deviation between the PID output value and an output value necessary for maintaining a target temperature TGT, the fixed value setting unit 14 determines a fixed value O on the basis of the PID output value or the like (ST303).

A method for determining the fixed value O is not particularly limited, and the fixed value O may be calculated from a table prepared in advance, for example.

In such a case, a plurality of tables can be provided corresponding to a plurality of values for a target temperature TGT.

Here, the temperature processing unit 1 according to the present technology adds a fixed value O to a PID output value output from the PID control unit 11 to avoid occurrence of undershoot and/or overshoot.

Therefore, examples of a table used for determining a fixed value O by a method illustrated in FIG. 6 include a configuration in which a reference value corresponding to a combination of a target temperature TGT and a PID output value is registered in advance, and a fixed value O corresponding to the target temperature TGT and the PID output value is determined, and the like.

Thereafter, the target value setting unit processing unit 2 gives an instruction to the erasure processing unit 16, and the erasure processing unit 16 erases a positive integral value which has been necessary for maintaining a change starting temperature TMP (ST304).

In addition, the PID coefficient determination unit 15 updates a PID coefficient from an existing PID coefficient to a new PID coefficient (ST305).

Furthermore, the addition unit 12 updates an existing fixed value O to a newly determined fixed value O as a result of new determination of the fixed value O (ST306).

Then, parameter setting is terminated (ST307). Control by the PID control unit 11 based on the newly determined PID coefficient, addition of the newly determined fixed value O, and control by the temperature control unit 13 are started with respect to a newly set target temperature TGT (see ST4 and subsequent steps in FIG. 3).

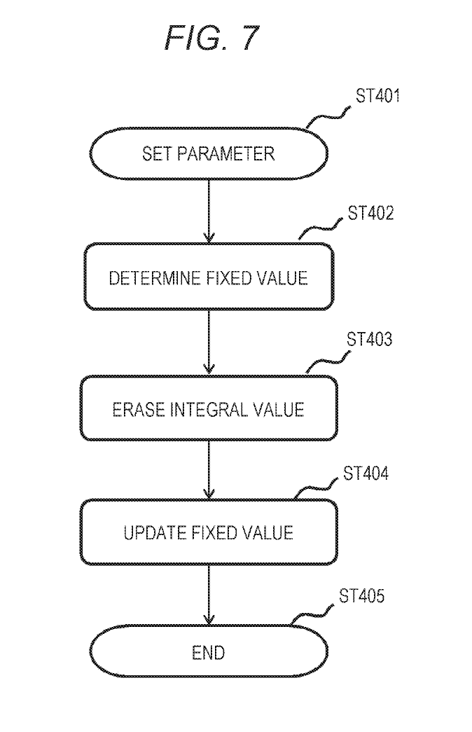

In addition, the temperature processing device I according to the present technology can adopt a method illustrated in FIG. 7 as a method for setting each parameter.

In a method illustrated in FIG. 5, a PID coefficient corresponding to a target temperature TGT is determined, and the target temperature TGT is controlled on the basis of the PID coefficient. Meanwhile, in the method illustrated in FIG. 7, the processing unit 2 sets a target temperature TGT, and then the processing unit 2 gives an instruction on start of parameter setting (ST401). Thereafter, the processing unit 2 gives an instruction to the fixed value setting unit 14, and the fixed value setting unit 14 determines a fixed value O corresponding to a target temperature TGT (ST402).

After the fixed value O is determined, the processing unit 2 gives an instruction to the erasure processing unit 16, and the erasure processing unit 16 erases a positive integral value which has been necessary for maintaining a change starting temperature TMP (ST403).

In addition, the addition unit 12 updates a fixed value O already set to a newly determined fixed value O as a result of new determination of the fixed value O (ST404).

Then, parameter setting is terminated (ST405). Control by the PID control unit 11, addition of the newly determined fixed value O, and control by the temperature control unit 13 are started with respect to the newly set target temperature TGT (see ST3 to ST6 in FIG. 3).

For example, the temperature processing unit 1 according to the present technology may perform a temperature change in stages from a change starting temperature TMP to a target temperature TGT. That is, for example, the temperature processing unit 1 may perform a temperature change in two stages from a change starting temperature TMP to a transient temperature and from the transient temperature to a target temperature TGT.

In such a case, it is preferable to adopt any one of parameter setting methods illustrated in FIGS. 4 to 7 at each stage.

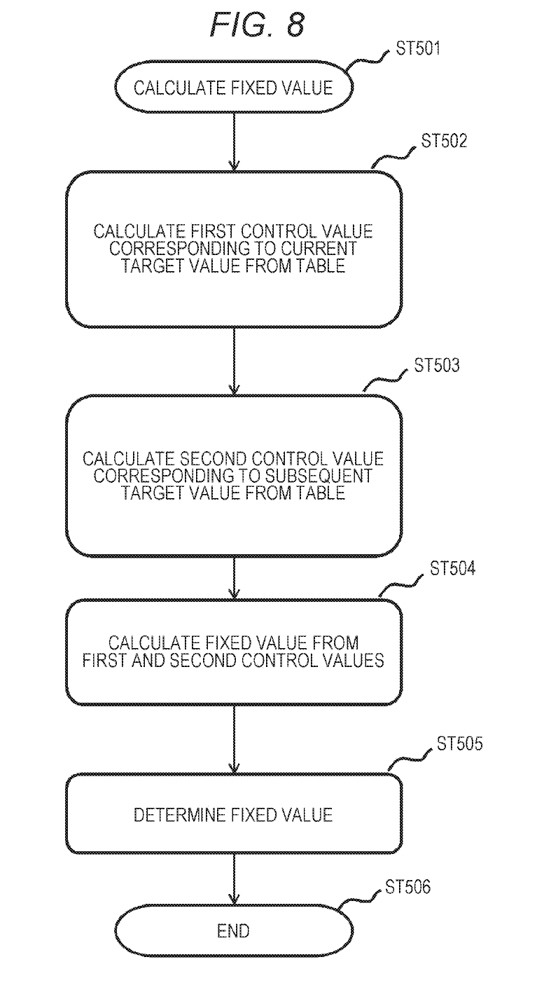

Next, an example of a method for calculating a fixed value O performed by the fixed value setting unit 14 will be described with reference to FIGS. 8 to 11. Note that the following description with reference to FIGS. 8 to 11 will illustrate, for example, a method for calculating a fixed value O in a case where a temperature change is performed in two stages from a change starting temperature TMP to a transition temperature and from the transient temperature to a target temperature TGT. However, the method for calculating a fixed value O illustrated in FIGS. 8 to 11 can be applied not only to temperature control in two stages but also to temperature control in a plurality of stages.

As illustrated in FIG. 8, in a case where a PID output value output from the PID control unit 11 does not coincide with an output value corresponding to a target temperature TGT, the processing unit 2 requests the fixed value setting unit 14 to calculate a fixed value O (ST501).

After it is requested to calculate the fixed value O, a control value (hereinafter, referred to as a “first control value”) with respect to an output value corresponding to a transient temperature set at the present time (hereinafter, referred to as an “output value corresponding to a current target temperature TGT”) is calculated on the basis of a table prepared in advance (ST502).

After the first control value is calculated, a control value (hereinafter, referred to as a “second control value”) with respect to an output value corresponding to a finally necessary target temperature (hereinafter, referred to as an “output value corresponding to a subsequent target temperature”) is calculated on the basis of a table prepared in advance (ST503).

Then, after the second control value is calculated, the fixed value setting unit 14 calculates a fixed value O on the basis of the first control value and the second control value (ST504). As a result, the fixed value setting unit 14 determines the fixed value O (ST505). After calculation of the fixed value O is terminated (ST506), the determined fixed value O is output to the addition unit 12 and added to the PID output value in the addition unit 12.

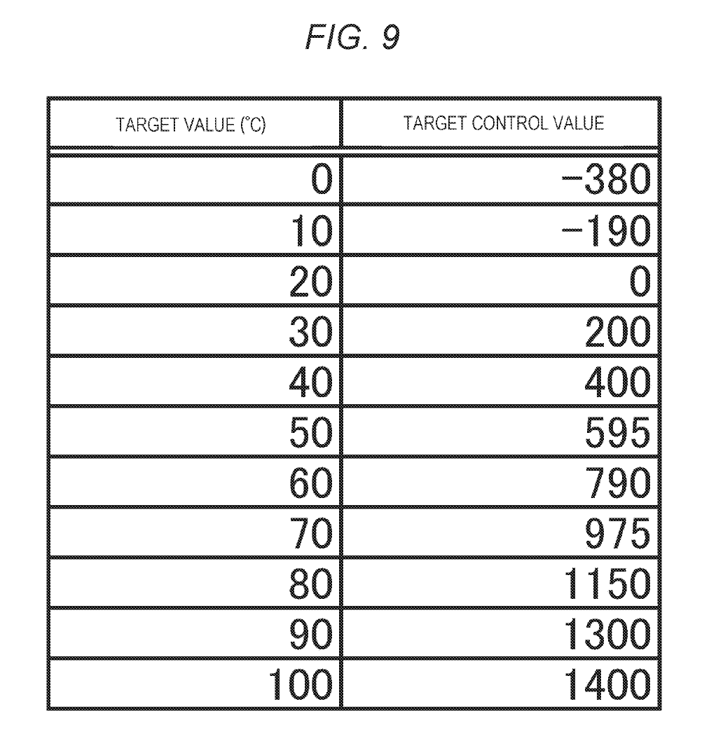

Here, a method for calculating a fixed value O illustrated in FIG. 8 will be described in detail using an example of a table applicable to the present technology illustrated in FIG. 9.

For example, a method for calculating a fixed value O in a case where a current temperature is 100° C., the temperature is lowered from 100° C. to a transient temperature 70° C., and further changed from the transient temperature 70° C. to a finally necessary temperature 45° C. will be described. That is, 70° C. corresponds to a current target temperature, and 45° C. corresponds to a subsequent target temperature.

First, in a case where a fixed value calculation request is made to the fixed value setting unit 14, the fixed value setting unit 14 calculates a first control value (975) corresponding to a current target temperature 70° C. from the table illustrated in FIG. 9. Thereafter, a second control value corresponding to a subsequent target temperature 45° C. is calculated from the table. In such a case, a control value (497.5) at 45° C. is calculated using linear interpolation on the basis of a control value (400) corresponding to 40° C. and a control value (595) corresponding to 50° C.

Then, on the basis of the first control value (975) and the second control value (497.5), the fixed value setting unit 14 determines an average value thereof (736.25) as a fixed value O.

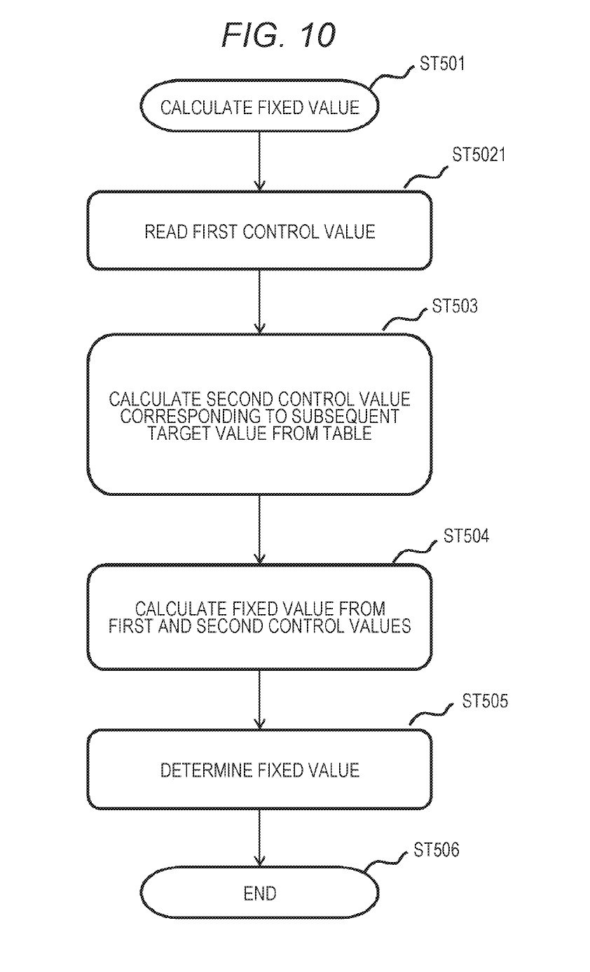

Next, a method different from the method for determining a fixed value O illustrated in FIG. 8 in the method for determining the first control value will be described with reference to FIG. 10.

In the method illustrated in FIG. 10, a control value output from the temperature control unit 13 at the present time, that is, a control value necessary for maintaining a current temperature in a temperature control target is read as a first control value (ST5021).

The method for determining a fixed value O illustrated in FIG. 10 is different from the method illustrated in FIG. 8 only in the step (ST5021) of determining the first control value. The other steps the same as the method illustrated in FIG. 8 are denoted by the same reference numerals, and description thereof is omitted.

The method for determining a fixed value O illustrated in FIG. 10 will be described in detail using the table illustrated in FIG. 9.

That is, in a case where a current temperature in the temperature control target is 70° C. and a control value necessary for maintaining this temperature is 940, this control value (940) is read as a first control value. When this first control value is read, for example, a control value may be fed back from the heating/cooling unit 3 to the processing unit 2, and the processing unit 2 may give the first control value to the fixed value setting unit 14.

Then, on the basis of the first control value (940) and a second control value (497.5) corresponding to a finally necessary temperature (45° C.), an average value (718.75) of these control values is determined as a fixed value O.

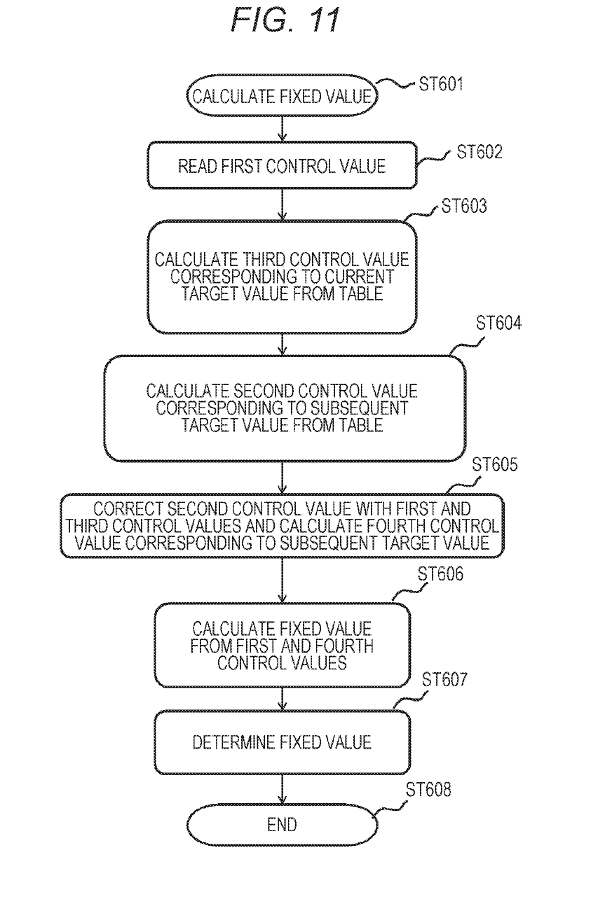

The table used for calculating the fixed value O may have a fixed discrete configuration. A method for determining the fixed value O using the table and a specific correction coefficient is also conceivable. This method will be described with reference to FIG. 11.

That is, in the method illustrated in FIG. 11, after calculation of a fixed value O is requested (ST601), similarly to the method illustrated in FIG. 10, a control value output from the temperature control unit 13 at the present time is read as a first control value (ST602).

Thereafter, a control value necessary for maintaining a current target temperature is calculated as a third control value on the basis of a table prepared in advance (ST603).

After the third control value is calculated, a control value necessary for maintaining a subsequent target temperature is calculated as a second control value on the basis of a table prepared in advance (ST604).

Thereafter, in the method illustrated in FIG. 11, the fixed value setting unit 14 calculates a correction coefficient on the basis of the first control value and the third control value, further corrects the second control value using the correction coefficient, and calculates a fourth control value based on the second control value and the correction coefficient (ST605).

Thereafter, the fixed value setting unit 14 calculates a fixed value O on the basis of the first control value and the fourth control value (ST606), and determines a fixed value O as a result (ST607). After calculation of the fixed value O is terminated (ST608), the determined fixed value O is output to the addition unit 12 and added to the PID output value in the addition unit 12.

A method for determining a fixed value O illustrated in FIG. 11 will be described using the table illustrated in FIG. 9.

First, similarly to the method illustrated in FIG. 10, in a case where the actual temperature in the temperature control target is 70° C. and a control value necessary for maintaining this temperature is 940, this control value (940) is read as a first control value.

Furthermore, a control value (975) at 70° C. is calculated as a third control value using the table.

Furthermore, similarly to the method illustrated in FIG. 8, using the table, on the basis of a control value (400) corresponding to 40° C. and a control value (595) corresponding to 50° C., a control value (497.5) at 45° C. is calculated using linear interpolation, and the control value is set as a second control value.

Thereafter, a correction coefficient (0.964=940/975) of the table is calculated from the first control value (940) and the third control value (975).

Then, the fixed value setting unit 14 corrects the second control value (497.5) using the correction coefficient (0.964), and calculates a fourth control value (479.64) necessary for maintaining 45° C.

Thereafter, on the basis of the first control value (940) and the fourth control value (479.64), the fixed value setting unit 14 determines an average value thereof (709.82) as a fixed value O.

The method for determining a fixed value O described with reference to FIGS. 8 to 11 is merely an example. The fixed value O is not particularly limited as long as being a value for inverting an integral value at the time when a target temperature TGT is reached.

If the fixed value O is the same as an output value corresponding to a change starting temperature TMP, in a case where a target value is changed from the change starting temperature TMP to a target temperature TGT, the same state as a state where a positive integral value which has been necessary for maintaining the change starting temperature TMP is not erased is obtained. As a result, occurrence of undershoot or overshoot cannot be avoided. Therefore, among values for inverting the sign of an integral value, as the fixed value O, it is preferable to use an intermediate value between an output value corresponding to a change starting temperature TMP and an output value necessary for maintaining a target temperature TGT, or an average value.

Incidentally, as described above, in the temperature processing unit 1 according to the present technology, the fixed value setting unit 14 is not an essential component, and, for example, the addition unit 12 may include a ROM or the like, and may calculate a fixed value O.

According to the temperature processing unit 1 according to the present technology configured as described above, a fixed value O for inverting the sign of an integral value is added to a PID output value output from the PID control unit 11. Therefore, for example, in a case where a temperature is lowered from a change starting temperature TMP to a target temperature TGT, a difference indicating negative is fed back until the target temperature TGT is reached, and the temperature is lowered. However, when the target temperature TGT is reached, an integral value takes a negative value, but a control value takes a positive value.

Therefore, when the target temperature TGT is reached, occurrence of undershoot can be avoided.

On the contrary, when a temperature is raised from the change starting temperature TMP to the target temperature TGT, a difference indicating positive is fed back until the target temperature TGT is reached, and the temperature is raised. However, when the target temperature TGT is reached, an integral value takes a positive value, but a control value takes a negative value.

Therefore, when the target temperature TGT is reached, occurrence of overshoot can be avoided.

2. Nucleic Acid Amplification Reaction Device

The present technology also provides a nucleic acid amplification reaction device including the temperature processing unit 1.

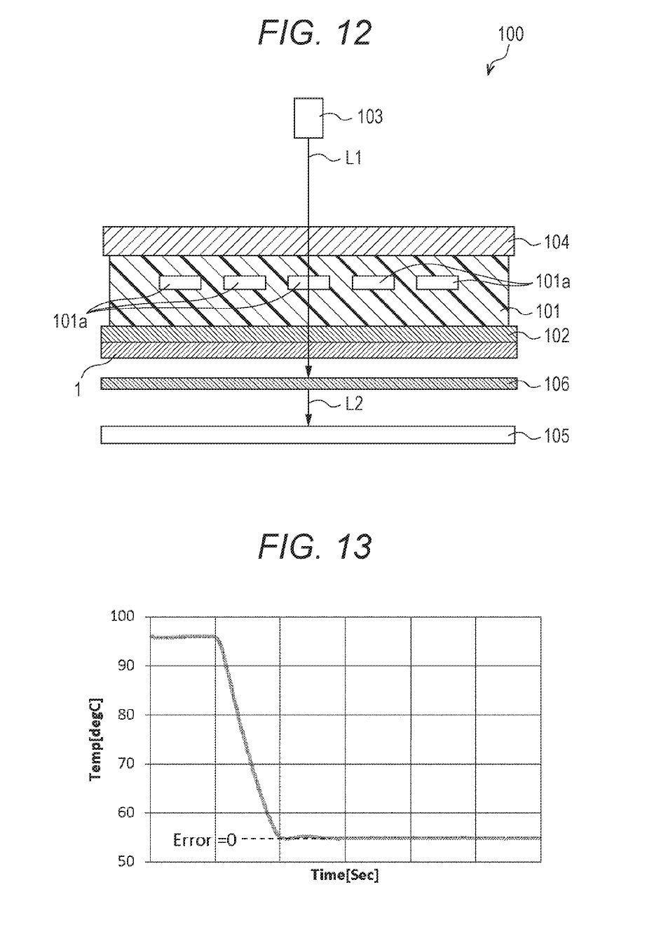

FIG. 12 is a conceptual diagram schematically illustrating a nucleic acid amplification reaction device 100 according to the present technology. The nucleic acid amplification reaction device 100 only needs to include at least the temperature processing unit 1 according to the present technology, and may include, as necessary, a reaction unit 101, a heating/cooling unit 102 for heating the reaction unit 101, a light source 103, a light guide plate 104 for guiding excitation light to the reaction unit 101, a fluorescence detection unit 105 for detecting fluorescence, a filter film 106 for transmitting only light with a specific wavelength, and a processing unit (not illustrated) for outputting temperature control information to the temperature processing unit 1, usually used for a nucleic acid amplification reaction device. Each component will be described below. Note that an operation performed by the processing unit and a configuration thereof are the same as those of the processing unit 2 described above, and therefore description thereof is omitted here.

(1) Temperature Processing Unit

The temperature processing unit 1 included in the nucleic acid amplification reaction device 100 according to the present technology outputs a control value for temperature control to the heating/cooling unit 102. The temperature processing unit 1 has the same configuration and performs the same operation as the temperature processing unit 1 according to the present technology described above, and therefore description thereof is omitted here.

(2) Reaction Unit

The nucleic acid amplification reaction device 100 according to the present technology includes the reaction unit 101 for causing a target DNA to react. The reaction unit 101 includes, for example, a plurality of wells 101a, and performs a specific reaction in each of the wells 101a. The configuration of the reaction unit 101, particularly the configuration of each of the wells 101a is not particularly limited, and a suitable shape and capacity can be used appropriately.

The capacity of each of the wells 101a is not particularly limited. However, a micro space is desirably used. Specifically, a capacity of 1 μL or less is desirably used. By using such a micro space, the amount of a reaction solution necessary for the wells 101a is small. Therefore, temperature control and the like can be performed with high accuracy and reaction time can be shortened.

A material of the reaction unit 101 is not particularly limited, and can be appropriately selected in consideration of a purpose of measurement, ease of processing, and the like. For example, low fluorescent light emitting plastic, glass or the like can be used as a material of the reaction unit 101.

In addition, the reaction unit 101 may be detachable from the heating/cooling unit 102, the fluorescence detection unit 105, and the filter film 106. Alternatively, although not illustrated, the reaction unit 101 and the heating/cooling unit 102 may be formed into an integral structure, and the integral structure may be detachable.

(3) Heating/Cooling Unit

The nucleic acid amplification reaction device 100 according to the present technology may include the heating/cooling unit 102 for heating and cooling the wells 101a in the reaction unit 101. A control value output from the temperature processing unit 1 is input to the heating/cooling unit 102. The heating/cooling unit 102 lowers or raises the temperature of a reaction solution in each of the wells 101a to a specific temperature according to the control value. The structure or the like of the heating/cooling unit 102 is not particularly limited, but examples thereof include a Peltier element, a heater formed by a thin film transistor (TFT) and the like. Alternatively, the heating/cooling unit 102 may be formed by a heating resistor and may be a heater formed by a thin film transistor. Examples of the heating resistor include platinum (Pt), molybdenum (Mo), tantalum (Ta), tungsten (W), silicon carbide, molybdenum silicide, a nickel-chromium alloy, an iron-chromium-aluminum alloy, and the like. The type of the thin film transistor is not particularly limited, and polysilicon, α-silicon or the like can be used appropriately, for example.

(4) Light Source

The nucleic acid amplification reaction device 100 according to the present technology preferably includes, as an optical means capable of irradiating the wells 101a in the reaction unit 101 with excitation light with a specific wavelength, the light source 103 and the light guide plate 104 for introducing excitation light into each of the wells 101a.

The type of the light source 103 is not particularly limited as long as emitting light with a specific wavelength, but a white or monochromatic light emitting diode (LED) is preferably used. By using a light emitting diode, it is possible to easily obtain light not containing unnecessary ultraviolet rays or infrared rays.

In the nucleic acid amplification reaction device 100 according to the present technology, an installation location of the light source 103 and the number of light sources are not particularly limited. A structure may be adopted in which a plurality of the light sources 103 is provided for the plurality of wells 101a in the reaction unit 101 and excitation light L1 is directly emitted toward each of the wells 101a corresponding to each of the light sources 103. In this case, for example, each of the wells 101a can be directly irradiated with each of the light sources 103. Therefore, by increasing the excitation light amount and controlling the excitation light amount individually, all the wells can be irradiated with excitation light uniformly.

(5) Light Guide Plate

The light guide plate 104 is used for guiding the excitation light L1 emitted from each of the light sources 103 to each of the wells 101a in the reaction unit 101. The excitation light L1 is introduced into the light guide plate 104, and a fluorescent substance in a reaction solution in each of the wells 101a can be excited with a uniform light amount. The configuration of the light guide plate 104 is not particularly limited, and a known light guide plate can be appropriately used.

(6) Fluorescence Detection Unit

The nucleic acid amplification reaction device 100 according to the present technology may include the fluorescence detection unit 105. In response to the excitation light L1 with which the wells 101a have been irradiated, the fluorescence detection unit 105 detects and measures fluorescence L2 emitted by excitation of a fluorescent dye in an intercalated probe. In the nucleic acid amplification reaction device 100 according to the present technology, the configuration of the fluorescence detection unit 105 is not limited, and a photodiode can be used, for example.

(7) Filter Film

In the nucleic acid amplification reaction device 100 according to the present technology, the filter film 106 for transmitting only light with the wavelength of the fluorescence L2 is desirably disposed between each of the wells 101a of the reaction unit 101 and the fluorescence detection unit 105 corresponding thereto. By disposing the filter film 106 for transmitting only light with a specific wavelength between each of the wells 101a and the fluorescence detection unit 105, the detected fluorescence L2 can be efficiently extracted, and therefore analysis with higher accuracy can be performed. As the filter film 106, for example, a polarizing filter or the like can be used.

In the nucleic acid amplification reaction device 100 according to the present technology, a usually used PCR method can be performed. Specifically, by repeating a temperature cycle of “thermal denaturation—annealing (primer hybridization)→extension reaction” using (1) a target DNA to be amplified, (2) at least two oligonucleotide primers specifically bonded to the target DNA, (3) a buffer solution, (4) an enzyme, (5) a deoxyribonucleotide triphosphate such as dATP, dCTP, dGTP, or dTTP, and the like, the target DNA can be amplified so as to have a desired amount, for example.

In the nucleic acid amplification reaction device 100 according to the present technology as described above, in order to thermally denature a target DNA, in a case where the temperature of a reaction solution in each of wells 101a is heated to 94° C., in order to anneal a single-stranded DNA and a primer thereafter, it is necessary to lower the temperature of the reaction solution in each of wells 101a to about 55° C.

In such a case, the temperature processing unit 1 adds a specific fixed value O to a PID output value output from the PID control unit 11. This addition result is output to the heating/cooling unit 102, and temperature adjustment of the heating/cooling unit 102 is controlled.

Therefore, when the temperature of the reaction solution reaches about 55° C., an integral value takes a negative value, but a control value output from the temperature processing unit 1 takes a positive value.

Therefore, when the temperature of the reaction solution reaches about 55° C., occurrence of undershoot can be avoided.

That is, in a case where the temperature of the reaction solution is lowered for the purpose of annealing, it is possible to avoid that the temperature of the reaction solution falls below 60° C., and occurrence of hunting thereafter can be suppressed.

As a result, the nucleic acid amplification reaction device 100 according to the present technology can improve a reaction efficiency in the temperature cycle of “thermal denaturation→annealing (primer hybridization)→extension reaction”. As a result, the amount of a target nucleic acid can be analyzed with high accuracy. Furthermore, an amplification ratio of a target DNA can be controlled with high accuracy.

3. Temperature Processing Method

The present technology also provides a temperature processing method. The temperature processing method includes at least a PID control step, an addition step, and a temperature control step. In addition, as necessary, the temperature processing method may include a fixed value calculation step, a PID coefficient determination step, an erasure processing step, a target temperature setting step, and a heating/cooling step. Each step will be described below.

(1) Target Temperature Setting Step

In the temperature processing method according to the present technology, a step of setting a target temperature TGT is performed for each temperature change from a change starting temperature TMP to the target temperature TGT. In the target temperature TGT setting step, information regarding a change of a set temperature with time is sent from the storage unit 4 to the processing unit 2, and the processing unit 2 sets the target temperature TGT according to the information.

(2) Erasure Processing Step

In a conventional method for embodying a temperature change, in a case where a temperature is raised or lowered from a change starting temperature TMP to a target temperature TGT, an integral value in temperature control takes a positive or negative value. Therefore, when the target temperature TGT is reached, undershoot or overshoot may occur.

Therefore, the temperature processing method according to the present technology preferably includes an erasure processing step of erasing an integral value which has been necessary for maintaining the change starting temperature TMP at the time when the target temperature TGT is set. In the temperature processing method, at the time when the processing unit 2 sets the target temperature TGT, the erasure processing unit 16 erases the integral value which has been necessary for maintaining the change starting temperature TMP.

(3) PID Coefficient Determination Step

In the temperature processing method according to the present technology, PID control is performed. Therefore, if a proportional band, integration time, and differentiation time are not appropriate, control becomes unstable, and occurrence of hunting may be induced.

Therefore, the temperature processing method according to the present technology may include a PID coefficient determination step for calculating a coefficient KP of a proportional element, a coefficient KI of an integral element, and a coefficient KD of a differential element in the PID control step before the PID control step.

In the temperature processing method according to the present technology, at the time when a target temperature TGT is input to the temperature processing unit 1, the PID coefficient determination unit 15 operates as necessary, and the PID coefficient determination unit 15 determines a coefficient KP of a proportional element, a coefficient KI of an integral element, and a coefficient KD of a differential element.

(4) Fixed Value Calculation Step

The temperature processing method according to the present technology may include, as necessary, a fixed value calculation step of calculating a fixed value O for inverting the sign of an integral value when a target temperature TGT is reached.

In the temperature processing method according to the present technology, in a case where a PID output value output from the PID control unit 11 does not coincide with an output value corresponding to a target temperature TGT, the processing unit 2 requests the fixed value setting unit 14 to calculate a fixed value O, and the fixed value setting unit 14 operates according to the request from the processing unit 2, and calculates a fixed value O necessary for temperature control to the target temperature TGT, for example, on the basis of a table as illustrated in FIG. 8.

(5) PID Control Step

In a case where a deviation is generated between an output value corresponding to a change starting temperature TMP and an output value corresponding to a target temperature TGT, in order to correct the deviation, the temperature processing method according to the present technology includes a PID control step of subjecting an output value corresponding to the target temperature TGT to PID control. In the temperature processing method according to the present technology, when the processing unit 2 sets a target temperature TGT, the PID control unit 11 performs PID control on the target temperature TGT because of output of the target temperature TGT, and a PID control step is thereby embodied.

(6) Addition Step

The temperature processing method according to the present technology includes an addition step of adding a specific fixed value O to a PID output value output in the PID control step in order to avoid occurrence of undershoot or overshoot during temperature control.

In the temperature processing method according to the present technology, the addition unit 12 judges that there is a deviation between a PID output value output from the PID control unit 11 and an output value corresponding to a target temperature TGT, and adds, to the PID output value, a fixed value O necessary for temperature control to the target temperature TGT.

(7) Temperature Control Step

The temperature processing method according to the present technology includes a temperature control step of controlling a temperature change from a change starting temperature TMP to a target temperature TGT on the basis of an addition result in the addition step.

In the temperature processing method according to the present technology, the temperature control unit 13 calculates a control value for controlling a temperature change from a change starting temperature TMP to a target temperature TGT according to an addition result output from the addition unit 12, and outputs the control value to the heating/cooling unit 3.
(8) Heating/Cooling Step

The temperature processing method according to the present technology may include a heating/cooling step of adjusting the temperature of a temperature control target according to the temperature control step. This step is embodied by a change of the temperature of a temperature control target by the heating/cooling unit 3 based on a control value output from the temperature processing unit 1. In a case where the temperature of the temperature control target is lower than a specific temperature, the temperature of the temperature control target is raised according to a result of the temperature control step. In a case where the temperature of the temperature control target is higher than the specific temperature, the temperature of the temperature control target is lowered according to the result of the temperature control step.

In the temperature processing method according to the present technology, in a case where a control value output in the temperature control step does not coincide with an output value corresponding to a target temperature TGT, until the control value coincides with the output value, the PID control step, the addition step, and the temperature control step are repeated.

In addition, the temperature processing method according to the present technology can also be applied to a case where the temperature of a temperature control target is repeatedly raised and lowered. A series of steps from the target value change request step to the heating/cooling step are performed for each temperature change in a temperature cycle.

The present technology may have the following configurations.

(1)

A temperature processing device including:

a PID control unit;

an addition unit configured to add a fixed value set between an output value corresponding to a change starting temperature and an output value corresponding to a target temperature to an output value output from the PID control unit; and

a temperature control unit configured to control a temperature change from the change starting temperature to the target temperature using the result of adding the output value and the fixed value.

(2)

The temperature processing device according to (1), further including a fixed value setting unit configured to calculate the fixed value on the basis of a difference between the output value and an output value corresponding to a target temperature.

(3)

The temperature processing device according to (1) or (2), in which the fixed value is an intermediate value between an output value corresponding to the change starting temperature and an output value corresponding to a target temperature.

(4)

The temperature processing device according to any one of (1) to (3), in which the fixed value setting unit calculates the fixed value on the basis of a predetermined first control value and a second control value determined on the basis of an output value corresponding to a subsequent target temperature.

(5)

The temperature processing device according to (4), in which

the fixed value setting unit calculates a fourth control value by updating the second control value using the first control value and a third control value calculated on the basis of an output value corresponding to a current target temperature, and

the fixed value setting unit calculates the fixed value on the basis of the first control value and the fourth control value.

(6)

The temperature processing device according to any one of (1) to (5), further including a PID coefficient determination unit configured to calculate a PID coefficient on the basis of an input value input to the PID control unit, in which the fixed value setting unit calculates the fixed value using the PID coefficient.

(7)

The temperature processing device according to claim 6, further including an erasure processing unit configured to delete an integral value output from the PID control unit.

(8)

A nucleic acid amplification reaction device including a temperature processing device including: a PID control unit; an addition unit configured to add a fixed value set between an output value corresponding to a change starting temperature and an output value corresponding to a target temperature to an output value output from the PID control unit; and a temperature control unit configured to control a temperature change from the change starting temperature to the target temperature using the result of adding the output value and the fixed value.

(9)

A temperature processing method including:

a PID control step of subjecting an input value to PID control;

an addition step of adding a fixed value set between an output value corresponding to a change starting temperature and an output value corresponding to a target temperature to an output value output from the PID control step; and

a temperature control step of controlling a temperature change from the change starting temperature to the target temperature using the result of adding the output value and the fixed value.

(10)

The temperature processing method according to (9), further including a fixed value calculation step of calculating the fixed value on the basis of a difference between the output value and an output value corresponding to a target temperature.

(11)

The temperature processing method according to (9) or (10), in which, in the fixed value calculation step, the fixed value is calculated as an intermediate value between an output value corresponding to the change starting temperature and an output value corresponding to a target temperature.

(12)

The temperature processing method according to any one of (9) to (11), in which, in the fixed value calculation step, the fixed value is calculated on the basis of a predetermined first control value and a second control value predetermined on the basis of an output value corresponding to a subsequent target temperature.

(13)

The temperature processing method according to (12), in which the fixed value calculation step includes an updating step of calculating an updated second control value by updating the second control value using the first control value and a third control value calculated on the basis of an output value corresponding to a current target temperature, and the fixed value is calculated on the basis of the first control value and the updated second control value.

(14)

The temperature processing method according to any one of (9) to (13), further including a PID coefficient determination step of calculating a PID coefficient in the PID control unit on the basis of an input value input to the PID control unit, in which

in the fixed value calculation step, the fixed value is calculated using the PID coefficient.

(15)

The temperature processing method according to any one of (9) to (14), further including an erasure processing step of deleting an integral value output from the PID control unit.

### EXAMPLES

Hereinafter, the present technology will be described in more detail on the basis of Examples. Note that Examples described below exemplify representative Examples of the present technology, and the scope of the present technology is not narrowly interpreted by Examples.

### Example 1

A nucleic acid amplification reaction device according to the present technology was manufactured, and temperature control was performed in a PCR method. That is, using the nucleic acid amplification reaction device according to the present technology, in the PCR method, temperature control was performed in a case where the temperature of a reaction solution was changed from 94° C. at which a double strand of a target DNA was formed into a single strand to about 55° C. at which annealing was performed.

A result of the temperature control is illustrated in FIG. 13. In the graph illustrated in FIG. 13, the vertical axis indicates temperature and the horizontal axis indicates time. In addition, as illustrated in FIG. 13, according to the nucleic acid amplification reaction device according to the present technology, in a case where the temperature was lowered from 94° C. to 55° C., it was confirmed that no undershoot occurred when the temperature reached 55° C. as a target temperature TGT. As a result, it was confirmed that hunting could be as small as possible in a case where the reaction solution was stabilized at 55° C.

### REFERENCE SIGNS LIST

I Temperature processing device
1 Temperature processing unit
2 Processing unit
3 Heating/cooling unit
11 PID control unit
12 Addition unit
13 Temperature control unit
14 Fixed value setting unit
15 PID coefficient determination unit
16 Erasure processing unit
17 Target value setting unit
111 Input unit
112 P control unit
113 I control unit
114 D control unit

1. A temperature processing device comprising:
a PID control unit;
an addition unit configured to add a fixed value set between an output value corresponding to a change starting temperature and an output value corresponding to a target temperature to an output value output from the PID control unit; and
a temperature control unit configured to control a temperature change from the change starting temperature to the target temperature using the result of adding the output value and the fixed value.

2. The temperature processing device according to claim 1, further comprising a fixed value setting unit configured to calculate the fixed value on the basis of a difference between the output value and an output value corresponding to a target temperature.

3. The temperature processing device according to claim 2, wherein the fixed value is an intermediate value between an output value corresponding to the change starting temperature and an output value corresponding to a target temperature.

4. The temperature processing device according to claim 3, wherein the fixed value setting unit calculates the fixed value on the basis of a predetermined first control value and a second control value determined on the basis of an output value corresponding to a subsequent target temperature.

5. The temperature processing device according to claim 4, wherein
the fixed value setting unit calculates a fourth control value by updating the second control value using the first control value and a third control value calculated on the basis of an output value corresponding to a current target temperature, and
the fixed value setting unit calculates the fixed value on the basis of the first control value and the fourth control value.

6. The temperature processing device according to claim 5, further comprising a PID coefficient determination unit configured to calculate a PID coefficient on the basis of an input value input to the PID control unit, wherein
the fixed value setting unit calculates the fixed value using the PID coefficient.

7. The temperature processing device according to claim 6, further comprising an erasure processing unit configured to delete an integral value output from the PID control unit.

8. A nucleic acid amplification reaction device comprising a temperature processing device including: a PID control unit; an addition unit configured to add a fixed value set between an output value corresponding to a change starting temperature and an output value corresponding to a target temperature to an output value output from the PID control unit; and a temperature control unit configured to control a temperature change from the change starting temperature to the target temperature using the result of adding the output value and the fixed value.

9. A temperature processing method comprising:
a PID control step of subjecting an input value to PID control;
an addition step of adding a fixed value set between an output value corresponding to a change starting temperature and an output value corresponding to a target temperature to an output value output in the PID control step; and
a temperature control step of controlling a temperature change from the change starting temperature to the target temperature using the result of adding the output value and the fixed value.

10. The temperature processing method according to claim 9, further comprising a fixed value calculation step of calculating the fixed value on the basis of a difference between the output value and an output value corresponding to a target temperature.

11. The temperature processing method according to claim 10, wherein, in the fixed value calculation step, the fixed value is calculated as an intermediate value between an output value corresponding to the change starting temperature and an output value corresponding to a target temperature.

12. The temperature processing method according to claim 11, wherein, in the fixed value calculation step, the fixed value is calculated on the basis of a predetermined first control value and a second control value predetermined on the basis of an output value corresponding to a subsequent target temperature.

13. The temperature processing method according to claim 12, wherein the fixed value calculation step includes an updating step of calculating an updated second control value by updating the second control value using the first control value and a third control value calculated on the basis of an output value corresponding to a current target temperature, and the fixed value is calculated on the basis of the first control value and the updated second control value.

14. The temperature processing method according to claim 13, further comprising a PID coefficient determination step of determining a PID coefficient in the PID control unit on the basis of an input value input to the PID control unit, wherein in the fixed value calculation step, the fixed value is calculated using the PID coefficient.

15. The temperature processing method according to claim 14, further comprising an erasure processing step of deleting an integral value output from the PID control unit.
